(19) United States
(12) Patent Application Publication
(10) Pub. No.: US 2010/0020952 A1
(43) Pub. Date: Jan. 28, 2010

(54) PRIVACY PROTECTION AND IDENTITY VERIFICATION IN ONLINE SOCIAL NETWORKS WITH EXTENSION TO PUBLIC SWITCHED TELEPHONE NETWORKS

(76) Inventors: Yiu Kau Leung, Morganville, NJ (US); Yiu Man Leung, Somerset, NJ (US)

Correspondence Address: Yiu Man Leung, 8208 Westover Way, Somerset, NJ, 08873, US

(21) Appl. No.: 12/509,433

(22) Filed: Jul. 24, 2009

Related U.S. Application Data
(60) Provisional application No. 61/083,935, filed on Jul. 27, 2008.

(51) Int. Cl. H04M 15/06

(52) U.S. Cl. 379/142.02

(57) ABSTRACT

The present invention describes a method and apparatus for protecting the privacy and verifying the identities of both calling and called parties in online social networks, with an extension to the public switched telephone networks. More specifically, this invention relates to the distribution of unique user identities in social networks to be used in public telephone networks providing privacy protection of both calling and called parties, while the calling party's identify can be verified. The user identity of the calling party, which is different from the real phone number of the calling party, can be used as part of the call filtering feature of the called party. None of the real phone numbers are revealed to the other party of a phone call using the public switched telephone networks.

### CROSS-REFERENCE TO RELATED APPLICATIONS

This application claims the benefit of Provisional Application No. 61/083,935, filed Jul. 27, 2008, the contents of which are incorporated herein in their entirety.

### TECHNICAL FIELD

This invention relates to privacy protection and identity verification in online social networks with an extension to the public telephone networks. More specifically, this invention relates to the distribution of unique user identities in social networks to be used in public telephone networks, providing privacy protection for both calling and receiving parties, while simultaneously permitting verification of the calling party's identity. No real phone numbers are revealed to the other party of a phone call using public switched telephone networks.

### BACKGROUND

The increasing adoption of online social networks by users from different backgrounds has increased the threats of identity theft and privacy intrusion.

Most online social network web sites allow users to create fictitious identities, known as user IDs by most systems. Users communicate online with these fictitious identities either in online text messages, referred to as instant messaging (IM), or in voice, with special voice over IP software applications like Skype, without knowing the true identities of the other parties. This protects the identity of the users as long as users do not give out any private information, such as telephone numbers. However, this limits communication methods to Internet-based methods only.

It is desirable to extend communication methods beyond online communication when one of the parties is not online for various reasons, such as when that party is traveling, when an Internet connection is not available, or when that party's computer is not turned on. The public switched telephone network (PSTN), including traditional land lines, the voice over IP network, and the mobile phone network, is the most popular and convenient way to contact another person.

The user ID provided by online social network communities protects the privacy of their users; however, currently, such user IDs cannot be used in the public switched telephone network to make calls.

A virtual phone number with call forwarding service, such as the service provided by Google's GrandCentral (also known as Google Voice) web site, hides the real phone number from the calling party. However, the virtual phone number works exactly the same as a real phone number. There is no easy way to distinguish these legitimate calls from calls made by an autodialing system, like those used in telemarketing. Moreover, the real number of the calling party might be revealed to the receiving party if the caller ID feature of the calling party is not blocked or disabled. On the other hand, if the caller ID feature of the calling party is disabled, then the identity of the calling party cannot be verified by the receiving party. This dilemma cannot be solved by the GrandCentral solution.

Caller ID service, as provided by most public switched telephone network service providers, is designed to allow the receiving party to verify the identity of the calling party before taking the call so that unwanted calls can be filtered. The dilemma is that either the calling party exposes its phone number so that the called party can validate the calling party's identification before taking the call, thus exposing the calling party's identity to the receiving party, or the calling party chooses to hide its phone number to protect its own identity and the calling party's identity cannot be validated by the called party. This dilemma cannot be resolved with the current offerings from the public switched telephone network.

Typically, to protect privacy, neither party wants to give out its real telephone number to the counterpart party, known only by a fictitious identity from an online social network. It is also desirable for the receiving party to verify the identity of calling party before taking the call so that unwanted calls can be filtered. However, the dilemma in today's public switched telephone network as described above prevents users from communicating using the network except by compromising privacy.

The prior art solutions do not present a solution for establishing voice communication between two parties using the public switched telephone network with protection of the privacy of both parties while allowing the verification of each of their identities.

The present invention provides a method and apparatus to allow users of online social networks to communicate with the public switched telephone network with privacy protection and verification of identity.

### SUMMARY OF THE INVENTION

The present invention permits users of online social networks to freely communicate with each other without the loss of privacy and, at the same time, verify the calling party's identity.

In one aspect of the invention, a social network community's hosting web server provides a web interface for users to maintain their own profiles. Members who wish to use the service are required to provide one or more real phone numbers in their profiles, which can be used to contact the members. These phone numbers, along with other personal information in each member's profile, are protected and only accessible by owners of that profile. There are existing technologies to provide protection of this information during transmission and access. The method to protect the information is outside the scope of this invention. Each member is assigned a unique member ID, preferably, but not necessarily, numeric. Only this member ID is needed to establish a voice communication between members of the community using the public switched telephone networks. For the purpose of the present invention description, the public switched telephone networks include the traditional land line local, regional, long distance, and international telephone networks, voice over IP networks and wireless mobile networks. The actual bearer of the voice network does not affect the nature of the present invention. Optionally, the member profile can include lists of member IDs that the member is and is not willing to accept incoming calls from.

Each community advertises one or more public switched telephone network access numbers for members to establish voice communication. There is no limit on how many members can call the access number(s) concurrently.

A member who wishes to communicate with another community member through the public switched telephone network will provision one or more phone numbers through which that member can be reached. These phone numbers may also be used to look up the member profile when caller ID is available.

Additional information may be provided by a member to allow filtering of incoming calls based on member ID and time of day, triggering various actions such as forwarding the call to one or more phone numbers, playing announcements, etc.

In another aspect of the invention, a call processing server processes incoming calls to the access numbers of a community. When a member calls one of the advertised access numbers of a community, the call processing server function is invoked. It associates the incoming caller with a member ID stored in the membership profile. After the calling party's identify is verified by the system, the caller is prompted for the receiving party's member ID. The system then retrieves the member profile of the receiving party from the member profile database using the receiving party's member ID and obtains the receiving party's real phone number from the member's profile. The incoming call is then bridged to the receiving party's real phone number and communication can commence. Other filtering features can be included as described in the detailed description of the present invention.

When a community member wishes to communicate with another community member via telephone, the member will access the system using the advertised community phone number. The system will associate the identity of the caller to the member by means of caller ID. In cases where the caller ID is blocked or not available, the member ID can be collected by an interactive voice response system. In all cases, a pin number or password can be collected by an interactive voice response system for stricter security. Once a caller's identity has been established, the caller will be known by the associated member ID throughout the system. The caller ID of the caller will not be forwarded or disclosed for further processing of the communication. The system then collects the member ID of the member with whom the caller wishes to communicate, again by means of the interactive voice response system. The system originates an outgoing call to one or more phone numbers associated with the member ID of the called party. The caller ID used to originate this call is not the same as the caller's phone number. The community accessed number is used instead, so that the receiving member can associate the call with the community. Optionally, the caller's member ID can be included as part of the caller ID. When the receiving member answers the call, the system will announce the member ID, alias, or recorded message of the originating member. Additionally, the system can announce a number of possible actions the receiving member can take, such as answering the call, rejecting the call, saving the incoming member ID to the accept call list, or saving the incoming member ID to the reject list. If the receiving member decides to answer the call, the two calls, one incoming from the originating member and one outgoing to the receiving member, will be bridged and communication can commence thereafter.

These and other embodiments of the present invention permit members to communicate using the public switched telephone network without the fear of revealing the real phone numbers of either party, while the receiving party can be assured the calling party is one that he or she is willing to accept. Members are further protected from unwanted calls from any autodialing systems using the community's access numbers.

### BRIEF DESCRIPTION OF THE DRAWINGS

FIG. 1 is a diagram of a social network community hosting web server with a database of user profiles.

FIG. 2 is a diagram showing the public switched telephone network communication call flow of using the invention with a voice over IP gateway.

FIG. 3 is a diagram showing the communication call flow using the invention with the call processing server directly interfacing to the public switched telephone network.

FIG. 4 is a flow diagram showing the call flow using the invention.

### DETAILED DESCRIPTION OF THE INVENTION

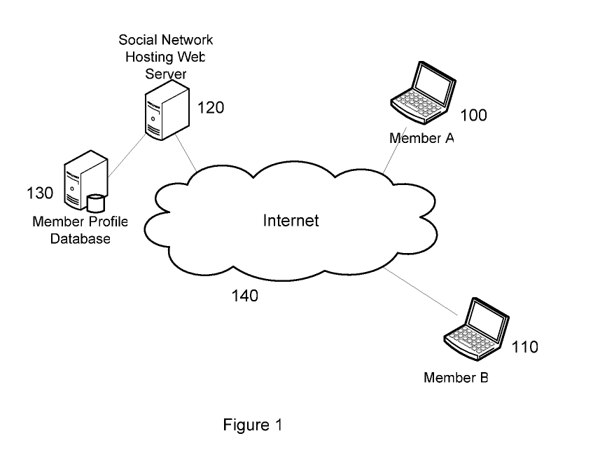

FIG. 1 is a representation of a network arrangement of the present invention that allows members of a social network community to maintain their membership profiles. Member A 100 and member B 110 can access the web site hosted by the community's web server 120 through the public Internet 140. There are well known methods to restrict access to the web site to registered members only. The access control to the web site with member IDs and passwords is beyond the scope of the present invention. The web site advertises one or more access phone numbers for members to communicate with.

Upon logging in to the web site, the member is provided with an option to sign up for the service provided by the present invention.

If the member decides to sign up for the service, a form is presented to the member requesting additional information to be used for the service. The information includes, but is not limited to:
a. One or more public switched telephone network phone numbers the member wishes to use for the phone communication. The phone numbers are used to receive calls and verify that the calls are originated by the registered member.
b. Optionally, the list of real phone numbers can include a priority and time-of-day range that the member wishes to accept the incoming calls.
c. An accept list of member IDs from which the member wishes to accept phone calls. Each of these member IDs can optionally include a time-of-day range during which the member wishes to accept calls from that member ID. Calls will be rejected if made out of the stated time range.
d. A reject list of member IDs from which the member does not want to accept any phone calls.
e. An option to reject all calls if the calling party is not in the accept list.
f. A favorite list of member IDs that the member wants to call.
g. PIN or password for accessing the service.

The member can update his or her profile data at any time through the web interface. Optionally, the member profile can be maintained by an interactive voice system by calling the access number of the community. The PIN or password is required to access the member profile to provide security.

A unique numeric ID is assigned to each member using this service. The numeric ID can optionally be the same as the member ID of the social network community. Optionally, an alphanumeric ID can be used. If an alphanumeric ID is used, the system will restrict the alphanumeric ID to a unique value so that it can be entered using a phone keypad. This unique numeric or alphanumeric member ID for the service is used for making phone calls to other members in the community using the present invention.

The member profile data 130 is stored in the form of a database, a table, or any other data structure, accessible by the web hosting server 120 as well as the call processing server 230 described in another aspect of the present invention.

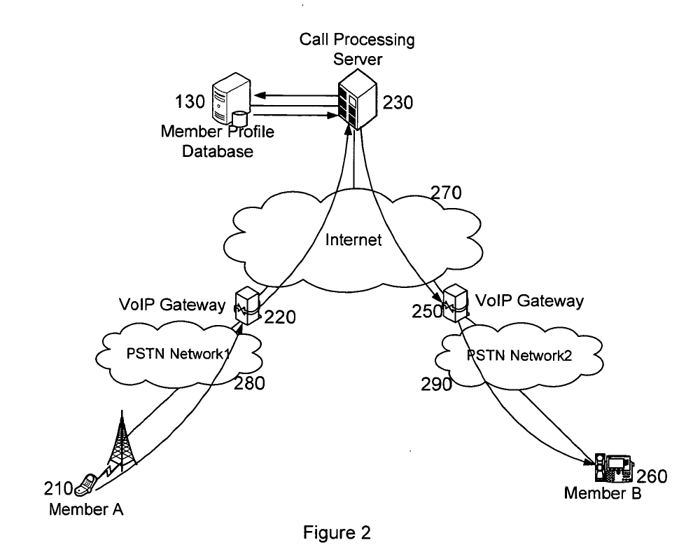

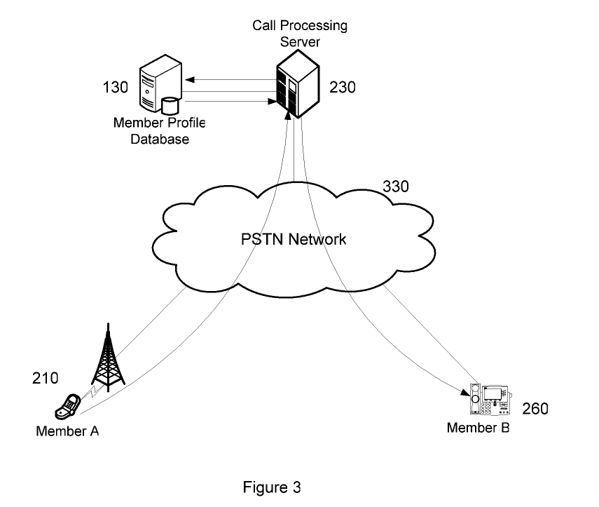

In another embodiment of the present invention, a call processing server 230 in FIG. 2 and FIG. 3 processes all incoming calls to the community's access numbers. There are existing methods to interface from the public switched telephone network to a call processing server. One of the known methods is using a voice over IP (VoIP) gateway using known protocols such as SIP or H.323, or any proprietary protocol. The call processing server accepts incoming calls from the VoIP gateway through the Internet or any IP network. The call processing server can also be connected to the public switch network directly using other known protocols such as TCAP, SS7, or any proprietary protocol to accept incoming calls and originate calls to the public switched telephone network. The method of interfacing to the public switched telephone network does not change the nature of the present invention.

The call processing server has the following unique functionalities:
a. Associate an incoming caller with a member ID stored in the membership profile by means of the caller ID of the calling party. Optionally, the service can be protected further with a PIN or password known only to the member.
b. If the caller ID of the calling party is not available, the calling party is prompted to input his or her member ID using a voice response system. The calling party can choose to enter the member ID on the keypad or say it verbally. In the latter case, the system includes speech recognition functionality. The calling party's member ID can be protected further with a PIN or password known only to the member.
c. After the calling party's identity is verified by the system by matching one of the member profiles in the member profile database 130, the caller is prompted for the receiving party's member ID. The calling party can choose to enter the member ID on the keypad or say it verbally. In the latter case, the system includes speech recognition functionality.
d. Optionally, the calling party can select the receiving party's member ID from the favorites list of the calling member's profile.
e. Retrieve the member profile of the receiving party from the member profile database using the member ID.
f. Verify that the calling party's member ID is in the accept list if this feature is included.
g. Reject the call if the calling party's member ID is in the reject list.
h. Retrieve the receiving party's real phone number from the member's profile.
i. Forward the call to the receiving party's real phone number using an existing call forwarding feature.
j. Optionally, the calling party's member ID is included in the forwarded call in the caller ID. In any case, the original phone number of the calling party is not revealed to the receiving party.
k. If the calling party's member ID is not in the reject list or the accept list and the option to reject calls not in the accept list is not selected, the calling member's ID is announced when the call is picked up. The receiving party has the option to accept the call, reject the call, add the calling member's ID to the one or more of the reject list, the accept list, or the favorite list.
l. Provide billing information to the community or any service providers.
m. Save call history in both parties' profiles for later retrieval.

One exemplary implementation of the present invention is a SIP server with the above the feature extensions acting as the call processing server 230 in FIG. 2. The SIP server 230 is connected to the public Internet or a private IP network provided by the service provider via the TCP/IP protocol. The SIP server is connected to the member profile database server 130.

When a member A 210 and member B 260 want to make a phone communication using the public switched telephone network, they first exchange their member IDs. In one exemplary scenario, member A 210 wants to originate calls to member B 260. Member B 260 can optionally store the member ID of member A 210 in the accept call list in member B's member profile.

At any time when member A 210 wants to call member B 260, he or she first dials the community advertised access number serviced by the public switched telephone network. The public switched telephone network recognizes the phone number is for the community and connects the call to the call processing server 260 via the voice over IP gateway 220 to the public switched telephone network.

The call processing server 260 receives the incoming call and looks up the member profile of member A, based on the caller ID of the incoming call. If the member profile is found, member A's identity is verified. Optionally, an additional security measure may be added to prompt the caller to enter his or her PIN number or password. If the PIN or password matches the PIN or password that is stored in the member profile, the caller's identity is verified as eligible to use the service. The call processing server 260 then retrieves the member ID of member A for further processing.

Optionally, if the caller ID is not included in the incoming call message, an interactive voice response system can be used to ask member A to enter his or her member ID and PIN or password. Member A can enter his or her member ID on the keypad of the phone or use a voice response to the prompt. In the latter case, a voice recognition system is used to transform the voice response into a digital response. The member ID is then used to look up the member profile. If the member profile is found, the PIN or password entered by member A is compared to that stored in the member profile. If the PIN or password entered by member A matches what is stored in the member profile, member A's identity is verified to be eligible to use the service. The call processing server 260 then saves the member ID of member A for further processing.

Once member A's identity has been established by one of the above methods, member A is known by the associated member ID of member A throughout the system. Member A's phone number or any other personal information of member A is not forwarded or disclosed for further processing of the communication.

The system then collects the member ID of member B, with whom member A wishes to communicate, again by means of the interactive voice response system. Member A may choose to enter the member ID with the keypad of the phone or verbally. In the latter case, the voice recognition system is used to transform the voice response into a digital response.

The system then retrieves the member profile of member B from the member profile database 130. If the retrieval fails because the member ID of member B does not exist in the system, the call is rejected.

If the member profile of member B is retrieved successfully from the database, member B is verified to be eligible to receive calls from other members with the services provided by the present invention.

The filtering data such as time-of-day to receive calls, accept call list, and reject call list are retrieved from the member B's profile.

If the incoming call satisfies all filtering criteria, then the call is accepted for further processing; otherwise, the call is rejected.

The system then retrieves the list of real phone numbers through which member B can be reached from member B's member profile data, along with the calling instructions, including but not limited to time-of-day, priority, and forwarding calls to one or more phones.

The system then originates an outgoing call to one or more phone numbers based on the calling instructions. Methods of originating a call with the SIP protocol are well known to those who are familiar with the art. The caller ID used to originate this call is not the same as member A's phone number. The community access number can be used so that the receiving member can associate the call with the community. Optionally, the member ID of member A can be included as part of the caller ID.

When member B answers the call, the system will announce the member ID of the originating member.

Additionally, the system can announce a number of possible actions member B can take, including answering the call, rejecting the call, or saving the incoming member ID to the reject call list, accept call list and/or favorite list.

If member B decides to answer the call, the two calls, one incoming from the originating member A and one outgoing to the receiving member B, will be bridged and communication can commence hereafter. The method of bridging the calls with the SIP protocol is well known to those who are familiar with the art.

When the communication concludes, the system can optionally announce a number of possible actions member B can take, such as saving the incoming member ID to the reject call list; accept call list and/or favorite list.

Billing information for the call, both on the originating call by member A and the call made on behalf of member A to member B, is collected at the call processing server 260. The service provider of the present invention can use the billing information to bill member A and optionally member B.

If member B chooses to save the member ID of member A for later processing, the system saves the member ID of member A to the reject call list, the accept call list and/or favorite list of the member profile of member B according to the response of the member B.

The signaling protocol used in call processing server 260 in the above exemplary implementation to accept and originate calls can be replaced by other well known signaling protocols, such as H.323, or a proprietary protocol. The protocol used in the call processing server to accept and originate calls does not change the nature of the present invention.

In yet another exemplary implementation of the present invention, as shown in FIG. 3, the call processing server 260 is connected directly to the public switched telephone network. The call processing server 260 can be regarded as an additional feature of the current public switched telephone network. The interface protocol between the call processing server and the public switched network does not change the nature of the present invention.

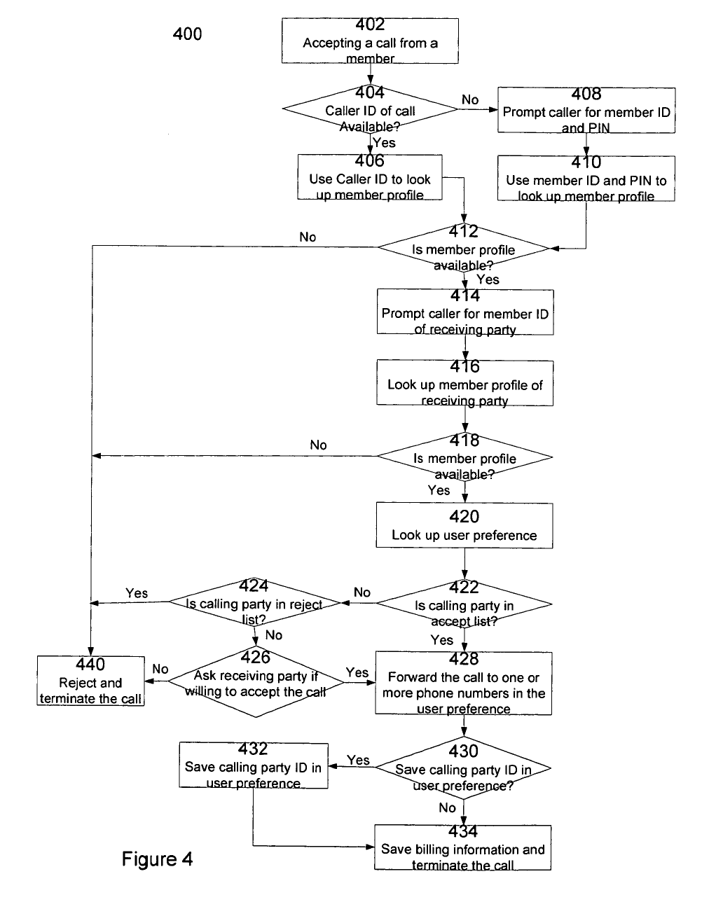

FIG. 4 is an exemplary flow diagram of processing a call using the present invention. Process 400 begins with the step 402 in which a call is accepted when a member makes a call to the advertised access numbers of the community. In step 404, it is determined whether the caller ID of the calling party is available. If so, in step 406, the member profile of the calling party is looked up using the caller ID and optionally the PIN or password provided by the calling party. If, in step 404, it is determined that the caller ID of the calling party is not available, then in step 408 the caller is prompted for his own member ID and PIN. In step 410, the member profile of the calling party is looked up using the member ID and PIN of the calling party. In step 412, it is determined whether the member profile of the calling party is available. If the member profile is not available, then in step 440, the call is rejected and terminated. If, in step 412, it is determined that the member profile of the calling party is available, then the identity of the calling party is verified. In step 414, the calling party is prompted for the member ID of the receiving party. In step 416, the member profile of the receiving party is looked up using the member ID of the receiving party. In step 418, it is determined whether the member profile of the receiving party is available. If it is determined that the member profile of the receiving party is not available, then in step 440, the call is rejected and terminated. If, in step 418, it is determined that the member profile of the receiving party is available, then receiving party's identity of the receiving party is verified and the user preference is looked up in step 420. In step 422, it is determined whether the calling party is in the accept list of the receiving party. If so, the call is forwarded to one or more of the phone numbers according to the user preference of the receiving party in step 428, without revealing the calling party's phone number. If, in step 422, it is determined that the calling party is not in the access list, then in step 424, it is determined whether the calling party is in the reject list. If so, the call is rejected and terminated in step 440. If, in step 424, it is determined that the calling party is not in the reject list, then the receiving party is offered an option whether or not to accept the call. If the receiving party is willing to accept the call, the call is forwarded to the receiving party in step 428, without revealing the calling party's phone number. At the conclusion of the call, in step 430, the receiving party is offered an option whether to save the calling party in one of the following lists in the user preference: accept list, reject list, or favorite list. If the receiving party wants to save the information, the calling party's member ID is saved in the accept list, the reject list or favorite list, depending on the receiving party's response. In step 434, the billing information of the call is saved and the call is terminated.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims

What is claimed is:

1. A method for allowing members of social network communities to communicate using the public switched telephone network without fear of revealing the real phone numbers of both parties, while the called party can be assured the calling party is one that he or she is willing to accept, comprising:
advertising access phone numbers for each community through which the members can call each other with the public switched telephone network;
assigning a unique member ID to each member;
a member profile storing each member's information for each community;
a member profile interface allowing members access, with a PIN or password, to their member profile information stored in a database;
accepting a call to any one of the access phone numbers of an online community from a member;
accessing the member profile;
associating the calling party with the member ID of the caller;
associating the called party with the member ID provided by the caller when making the call;
verifying the identity of the calling party against the member profile database;
filtering the calls without knowing the calling party's public switch telephone network number;
originating a phone call to the called party via the public switched telephone network on behalf of the caller and bridging the incoming call to the called party.
saving the member ID of the calling party in the member profile of the called party;
hiding the real phone numbers of each party from the other.

2. The method of claim 1, wherein the access phone numbers for the communities are phone numbers accessible by public switched telephone network.

3. The method of claim 1, wherein the member profile comprising:
a unique member ID assigned by the present invention,
a PIN or password that the member uses to access the member profile and the service provided by the present invention,
one or more public switched telephone network phone numbers through which that the member can be reached,
a list of member IDs that the member will accept incoming calls from (hereafter referred to as accept list),
a list of member IDs from which the incoming calls will be rejected (hereafter referred to as reject list),
a list of member IDs that the member wants to call (hereafter referred to as favorite list),
a list of user preferences.

4. The method of claim 3, wherein the user preferences comprising:
a list of the time-of-day ranges for each phone number listed in the member profile,
a list of actions taken during the time-of day ranges,
a list of calling party member IDs with special processing instructions.

5. The method of claim 4, wherein the actions include: accepting incoming calls, rejecting incoming calls, forwarding the incoming call to another phone number, playing a prerecorded announcement, and ringing multiple phone numbers simultaneously.

6. The method of claim 4, wherein the special processing instructions for a particular member ID include accepting incoming calls, rejecting incoming calls, forwarding the call to one or more phone numbers based on time-of-day, playing a prerecorded announcement, and ringing multiple phone numbers simultaneously.

7. The method of claim 1, wherein the member profile interface comprising:
a web interface provided by the advertising community as part of the Internet web site,
an interactive voice response system accessible by any public switched telephone network.

8. The method of claim 1, wherein the incoming call is associated to the member ID of the calling member by using the originating caller ID, caller ID together with a correct PIN or password collected by an interactive voice response system, or the member ID together with the correct PIN or password collected by an interactive voice response system.

9. The method of claim 1, wherein the member profile of the called party is accessed using the member ID of the called party provided by the calling party.

10. The method of claim 1, wherein the incoming call will be rejected if the member ID of the calling party is not in the member profile database, because the identity of the calling party is verified by the existence of the member profile in the database.

11. The method of claim 1, wherein the incoming call will be rejected if the member ID of the called party is not in the member profile database, because the identity of the called party is verified by the existence of the member profile in the database.

12. The method of claim 1, wherein the incoming call will be automatically accepted if the member ID of the calling party is in the accept list of the called party.

13. The method of claim 1, wherein incoming call will be automatically rejected for further processing if the member ID of the calling party is in the reject list of the called party.

14. The method of claim 1, wherein a call will be originated to the called party and announce the member ID of the calling party if the member ID of the calling party is not in the accept or reject list. The called party will have a choice of whether to accept or reject the call.

15. The method of claim 14, wherein a call will be originated on behalf of the calling party using one or more of the phone numbers through which the called party can be reached, based on the user preference of the called party.

16. The system of claim 14, wherein the member ID of the calling party is used as the caller ID of the call.

17. The method of claim 14, wherein the advertised access number of the community can be alternatively used as the caller ID.

18. The method of claim 14, wherein the real phone number of the calling party will not be revealed to the called party.

19. The method of claim 1, wherein the called party will be offered the options to save the member ID of the calling party to one or more of the reject list, the accept list, or the favorite list in the member profile of the called party upon termination of the call.

20. A call processing server for providing the call processing service of this invention, the server comprising:
a processor to execute computer instructions;
a memory to store computer program instructions executable by a processor;
a member profile database; and
computer program instructions stored in the memory and executable to perform the steps of:
accepting a call to any one of the access phone numbers of an online community from a member,
accessing the member profile using the calling party's caller ID or member ID,
associating the calling party with the member ID of the caller,
verifying the identity of the calling party against the member profile database,
associating the called party with the member ID provided by the caller when making the call,
filtering the calls without knowing the calling party's public switch telephone network number,
originating a phone call to the called party via the public switched telephone network on behalf of the caller, and bridging the incoming call to the called party,
saving the member ID of the calling party in the member profile of the called party,
hiding the real phone numbers of both parties from each other.

21. The system of claim 20, wherein the call processing server can connect to the public switched telephone network using one or a combination of the following methods:
through one or more voice over IP gateways using the TCP/IP protocol, or any proprietary protocol,
connect to the public switched telephone network directly using one or more well known call processing protocols, such as TCAP and SS7, or any proprietary protocol

22. The system of claim 20, wherein the member profile database comprising for each member:
a unique member ID assigned by the present invention,
a PIN or password that the member uses to access the member profile and the service provided by the present invention,
one or more public switched telephone network phone numbers through which the member can be reached,
a list of member IDs that the member will accept incoming calls from (hereafter referred to as accept list),
a list of member IDs from which the incoming calls will be rejected (hereafter referred to as reject list),
a list of member IDs that the member wants to call (hereafter referred to as favorite list),
a list of user preferences.

23. The system of claim 22, wherein the user preferences comprising:
a list of the time-of-day ranges for each phone number listed in the member profile,
a list of actions taken during the time-of day ranges,
a list of calling party member IDs with special processing instructions.

24. The system of claim 23, wherein the actions include, accepting incoming calls, rejecting incoming calls, forwarding the incoming call to another phone number, playing a prerecorded announcement, and ringing multiple phone numbers simultaneously.

25. The system of claim 23, wherein the special processing instructions for a particular member ID include accepting incoming calls, rejecting incoming calls, forwarding the call to one or more phone numbers based on time-of-day, playing a prerecorded announcement, and ringing multiple phone numbers simultaneously.

26. The system of claim 20, wherein the call processing server accepts calls to any one of the access phone numbers for the community.

27. The system of claim 20, wherein the call processing server can associate the incoming call to the member ID of the calling member by using the originating caller ID, caller ID together a correct PIN or password collected by an interactive voice response system, or a member ID together with the correct PIN or password collected by an interactive voice response system.

28. The system of claim 20, wherein the call processing server can access the member profile of the called party using the member ID of the called party provided by the calling party.

29. The system of claim 20, wherein the call processing server will reject the call if the member ID of the calling party is not in the member profile database, because the identity of the calling party is verified by the existence of the member profile in the database.

30. The system of claim 20, wherein the call processing server will reject the call if the member ID of the called party is not in the member profile database, because the identity of the called party is verified by the existence of the member profile in the database.

31. The system of claim 20, wherein the call processing server will automatically accept the incoming call for further processing if the member ID of the calling party is in the accept list of member IDs of the called party.

32. The system of claim 20, wherein the call processing server will automatically reject the incoming call for further processing if the member ID of the calling party is in the reject list of member IDs of the called party.

33. The system of claim 20, wherein the call processing server will originate a call to the called party and announce the member ID of the calling party if the member ID of the calling party is not in the accept or reject list. The called party will have a choice of whether to accept or reject the call.

34. The system of claim 20, wherein the call processing server will be based on user preferences, selecting one or more phone numbers that the called party can be reached at the time of a call and originating a call to the selected number(s) on behalf of the calling party.

35. The system of claim 34, wherein the member ID of the calling party is used as the caller ID of the call.

36. The system of claim 34, wherein the advertised access number of the community can alternatively be used as the caller ID of the call.

37. The system of claim 34, wherein the real phone number of the calling party making the call from will not be revealed to the called party.

38. The system of claim 20, wherein the call processing server will offer the called party the ability to save the member ID of the calling party to one or more of the reject list, the accept list, and the favorite list in the member profile of the called party upon termination of the call.

39. A computer program product for providing the call processing service of this invention, comprising:
a computer readable storage medium;
computer program instructions recorded on the computer readable medium, executable by a processor, for performing the steps of:
accepting a call to any one of the access phone numbers of an online community from a member,
accessing the member profile using the calling party's caller ID or member ID,
associating the calling party with the member ID of the caller,
associating the called party with the member ID provided by the caller when making the call,
verifying the identity of the calling party against the member profile database,
filtering the calls without knowing the calling party's public switch telephone network number,
originating a phone call to the called party via the public switched telephone network on behalf of the caller, and bridging the incoming call to the called party,
saving the member ID of the calling party in the member profile of the called party,
hiding the real phone numbers of both parties from each other.

40. The computer program product of claim 40, wherein the computer instructions perform a method according to claims 1 to 19.
